(19) United States
(12) Patent Application Publication
(10) Pub. No.: US 2024/0246691 A1
(43) Pub. Date: Jul. 25, 2024

(54) AIRCRAFT COMPRISING A FUEL TANK

(71) Applicant: Airbus Operations SAS, TOULOUSE (FR)

(72) Inventors: Yannick CAZABONNE, TOULOUSE (FR); Gilles CHAULET, TOULOUSE (FR)

(21) Appl. No.: 18/417,319

(22) Filed: Jan. 19, 2024

(30) Foreign Application Priority Data
Jan. 24, 2023 (FR) 2300622

(51) Int. Cl. B64D 37/06; B64D 37/00

(52) U.S. Cl. CPC B64D 37/06; B64D 37/005

(57) ABSTRACT

An aircraft comprising a fuel tank in which a lower wall of the tank corresponds to a panel of a structure of the aircraft, the panel being provided with reinforcing profiles, a fuel retention zone being associated with at least one reinforcing profile, the retention zone being delimited by the lower wall of the tank and by the reinforcing profile. The tank has a set of passive fuel transfer systems, each system being installed between a fuel retention zone associated with a reinforcing profile and a lower part of the tank. Each passive fuel transfer system is configured to allow fuel retained in the retention zone to be siphoned in such a manner that this fuel is transferred to a pumping zone in the lower part of the tank.

### CROSS-REFERENCES TO RELATED APPLICATIONS

This application claims the benefit of French Patent Application Number 2300622 filed on Jan. 24, 2023, the entire disclosure of which is incorporated herein by way of reference.

### FIELD OF THE INVENTION

The invention relates to the field of fuel tanks in aircraft. An aircraft 1, such as that illustrated in FIG. 1, generally comprises at least one fuel tank to enable fuel to be supplied to propulsion engines 3 of the aircraft. This tank is generally integrated in a structure of the aircraft such as a wing 4, a central wing box 5, a lower part of a fuselage 2, etc. In one embodiment, a lower wall of the tank corresponds to a panel of the structure of the aircraft, for example an underside panel of the wing 4 or an underside panel of the central wing box 5. For reasons of structural integrity, this panel is generally provided with reinforcing profiles arranged substantially perpendicularly in relation to the panel. This is particularly the case when the panel is a panel made of self-stiffened composite material.

As shown in FIG. 2 and in FIG. 3, an underside panel 10 of a wing or a central wing box generally has a curved shape so that there are fuel retention zones 18 that are delimited by the reinforcing profiles 12 and the lower wall 14 of the tank corresponding to the underside panel 10. Consequently, when the fuel level decreases in the tank, a significant amount of fuel is retained in the different retention zones, said fuel being unable to reach a pumping zone 16 in a lower part of the tank to be pumped to the propulsion engines of the aircraft. Consequently, this fuel represents a weight that the aircraft carries but is unable to use to supply the propulsion engines.

### BACKGROUND OF THE INVENTION

In order to solve this problem, a known solution involves drilling drainage holes 15 in the reinforcing profiles 12, as illustrated in FIG. 4, in order to allow the fuel contained in the retention zones 18 to flow towards the pumping zone 16 located in the lower part of the tank. To ensure that the drilling of the drainage holes does not degrade the structural characteristics of the reinforcing profiles, reinforcing gussets 17 are attached to the reinforcing profiles 12 close to the drainage holes 15 by means of fixings 19. However, the addition of the reinforcing gussets leads to a significant increase in the weight of the aircraft. Furthermore, the drilling of drainage holes and the installation of gussets require complex machining operations and assembly operations that increase the manufacturing cost of the tank.

### SUMMARY OF THE INVENTION

The present invention aims to provide a solution to this problem. It relates to an aircraft comprising a fuel tank, such that a lower wall of the tank corresponds to a panel of a structure of the aircraft, said panel being provided with reinforcing profiles, a fuel pumping zone being provided in a lower part of the tank so as to allow fuel to be pumped to at least one fuel consumer, and a fuel retention zone being associated with at least one reinforcing profile, said fuel retention zone being delimited by the lower wall of the tank and by the reinforcing profile.

The aircraft is notable in that:
the tank comprises a set of passive fuel transfer systems, each system being installed between, on the one hand, a fuel retention zone associated with a reinforcing profile and, on the other hand, the lower part of the tank, and
each passive fuel transfer system is configured to allow fuel retained in the retention zone associated with the reinforcing profile to be siphoned in such a manner that this fuel is transferred to the pumping zone when the fuel level in the tank is such that the retention zone is not covered by fuel.

The increase in the weight of the aircraft resulting from the addition of the passive fuel transfer systems is lower than the increase in weight resulting from the addition of reinforcing gussets. Moreover, these systems are easy to install, without the need for complex machining or installation operations, since they are based on the principle of siphoning the fuel contained in the retention zones, in order to transfer it to the pumping zone. Hence, the solution according to the invention has the advantage of allowing the fuel contained in the retention zones to be drained to the pumping zone without causing too significant an increase in the weight of the aircraft and reducing the manufacturing cost of the tank compared with the prior solution involving the addition of reinforcing gussets.

According to various embodiments that can be considered individually or in combination:
each passive fuel transfer system comprises a pipe, a first end of which is located in the fuel retention zone and a second end is located in the lower part of the tank;
the pipe is configured in such a manner that it comprises a bend close to its first end, in order to bypass the reinforcing profile associated with the retention zone;
the first end of the pipe is located in a lower part of the retention zone;
each passive fuel transfer system comprises a bypass conduit, a first end of which is connected to the pipe, close to the second end of the pipe, and a second end of which opens freely into the lower part of the tank;
a non-return valve is serially mounted on the bypass conduit in such a manner as to prevent the circulation of fuel towards the second end of the bypass conduit;
each passive fuel transfer system comprises a float valve mounted on the second end of the pipe and configured in such a manner that it is closed when a fuel level in the lower part of the tank is sufficiently high to lift the float and in such a manner that it is open when the fuel level is not sufficiently high to lift the float.

### BRIEF DESCRIPTION OF THE DRAWINGS

The invention will be better understood by reading the following description and examining the accompanying figures.

FIG. 1, as previously described, is a view of an aircraft comprising a fuel tank.

FIG. 2, as previously described, schematically illustrates a lower part of an aircraft fuel tank.

FIG. 3, as previously described, is a detailed view of the lower part of the tank.

FIG. 4, as previously described, schematically illustrates an embodiment according to the prior art of a lower part of an aircraft fuel tank.

FIG. 5 schematically illustrates a lower part of an aircraft fuel tank comprising a fuel transfer system according to an embodiment of the invention.

FIG. 6, similar to FIG. 5, illustrates a first step of filling the tank.

FIG. 7, similar to FIG. 5, illustrates a second step of filling the tank.

FIG. 8, similar to FIG. 5, illustrates a third step of filling the tank.

FIG. 9, similar to FIG. 5, illustrates a first step of emptying the tank.

FIG. 10, similar to FIG. 5, illustrates a second step of emptying the tank.

FIG. 11, similar to FIG. 5, illustrates a third step of emptying the tank.

FIG. 12, similar to FIG. 5, illustrates a fourth step of emptying the tank, in which the tank is completely empty.

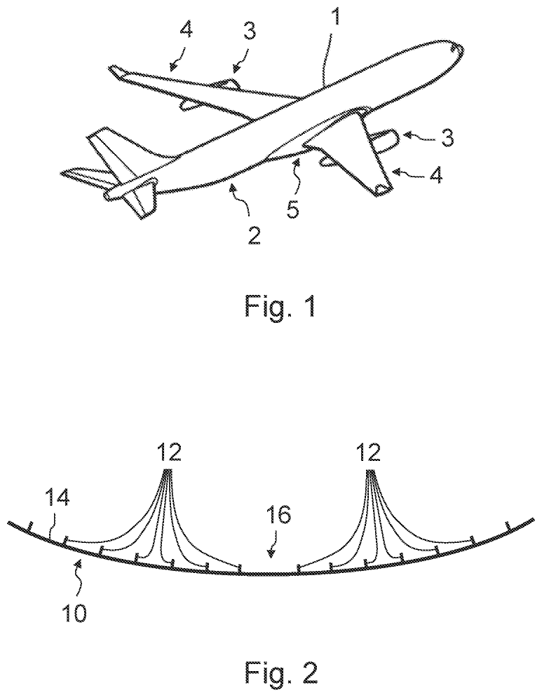

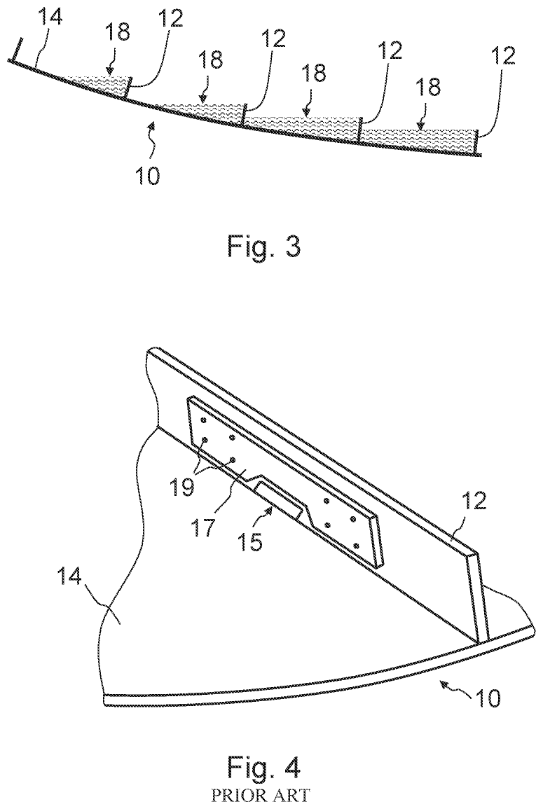

### DETAILED DESCRIPTION OF THE PREFERRED EMBODIMENTS

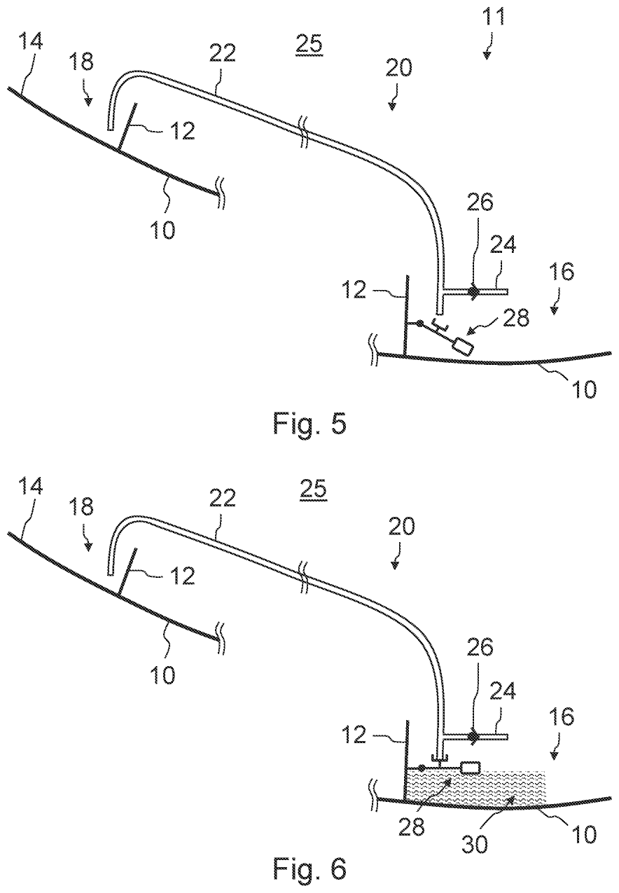

In one embodiment of the invention, an aircraft comprises a fuel tank 25 located within a structure of the aircraft, for example in a wing or in a central wing box of the aircraft. A lower part 11 of the tank, as depicted in FIG. 5, comprises a lower wall 14 corresponding to a panel 10 of the structure of the aircraft, such as an underside panel of the wing or of the central wing box of the aircraft. The underside panel 10 comprises a set of reinforcing profiles 12 integral with the lower wall 14 and extending towards the inside of the tank. A pumping zone 16 is provided in a lower part of the tank. This pumping zone corresponds notably to a low point of the tank and therefore to a low point of the lower part 11, as illustrated on the right side of the figure. The pumping zone 16 is designed to allow the fuel to be pumped to a fuel consumer, such as a propulsion engine of the aircraft. As previously indicated, a reinforcing profile 12 and the lower wall 14 of the tank define a fuel retention zone 18 associated with this reinforcing profile, as illustrated on the left side of the figure. The reinforcing profile 12 defining the retention zone 18 is, for example, a reinforcing profile distal from the pumping zone 16, such that other reinforcing profiles are positioned between this reinforcing profile 12 and the pumping zone 16. For the sake of clarity in the figure, these other reinforcing profiles are not shown and, as a result, the underside panel is shown interrupted. However, it should be understood that the underside panel 10 extends continuously between the right and left sides of the figure, in a similar way to the underside panel depicted in FIG. 2. The fuel tank further comprises a passive fuel transfer system 20. The passive fuel transfer system extends between the fuel retention zone 18 and the lower part of the tank, in which the pumping zone 16 is located. As will, moreover, be described in the following description, the passive fuel transfer system 20 is configured to allow fuel retained in the retention zone 18 associated with the reinforcing profile to be siphoned in such a manner that this fuel is transferred to the pumping zone 16 when the fuel level in the tank is such that the retention zone is not covered by fuel.

In the embodiment illustrated in FIG. 5, the passive fuel transfer system 20 comprises a pipe 22, a first end of which is located in the retention zone 18 and a second end is situated in the lower part of the tank. The pipe 22 is configured in such a manner that it comprises a bend close to its first end, in order to bypass the reinforcing profile 12 associated with the retention zone 18.

Advantageously, the passive system 20 further comprises a bypass conduit 24, a first end of which is connected to the pipe 22, close to the second end of the pipe 22, and a second end of which opens freely into the lower part of the tank. A non-return valve 26 is serially mounted on the bypass conduit 24 to prevent the flow of fuel towards the second end of the bypass conduit 24.

Advantageously, the passive system 20 also comprises a float valve 28 mounted on the second end of the pipe 22. This float valve is, for example, fixed on a reinforcing profile 12 of the panel 10. The float valve 28 is configured in such a manner that it is closed when the fuel level in the lower part of the tank is sufficiently high to lift the float and in such a manner that it is open when the fuel level is not sufficiently high to lift the float.

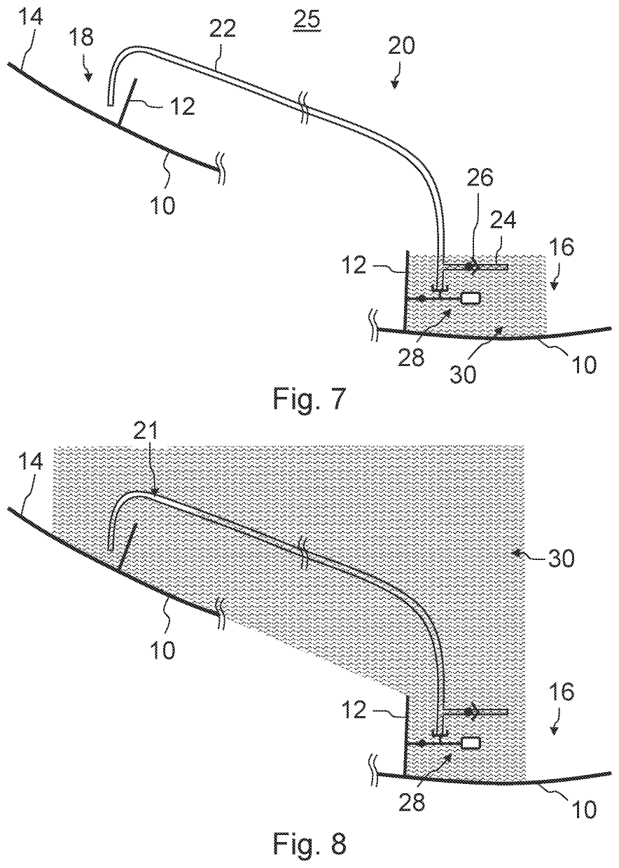

During operation, when the tank 25 is being filled, the fuel level 30 rises in the lower part of the tank until it reaches a first filling level as illustrated in FIG. 6. This has the effect of raising the float of the float valve 28 and therefore closing this valve. Consequently, the float valve 28 then closes the second end of the pipe 22. By continuing to fill the tank, the fuel level 30 rises in the lower part of the tank until it reaches a second filling level as illustrated in FIG. 7. The second end of the bypass conduit 24 is then submerged and fuel then enters the submerged part of the pipe 22 via the bypass conduit 24 and the non-return valve 26. By further continuing to fill the tank, the fuel level 30 rises in the tank until it reaches a third filling level as illustrated in FIG. 8. This third filling level is such that the reinforcing profile 12 associated with the retention zone 18 is submerged in the fuel. As a result of this, the retention zone 18 is then filled with fuel. The retention zone 18 is covered with fuel since the fuel level 30 is such that the reinforcing profile 12 is submerged in the fuel. During the filling of the tank to reach this third filling level, the pipe 22 continues to be filled with fuel via the bypass conduit 24. However, an air bubble 21 may remain in the pipe 22 close to its first end.

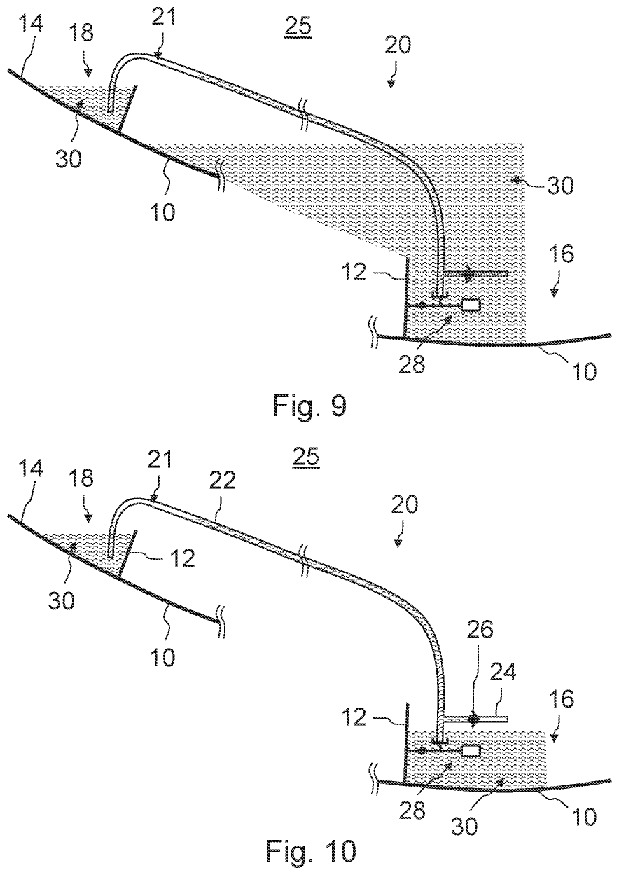

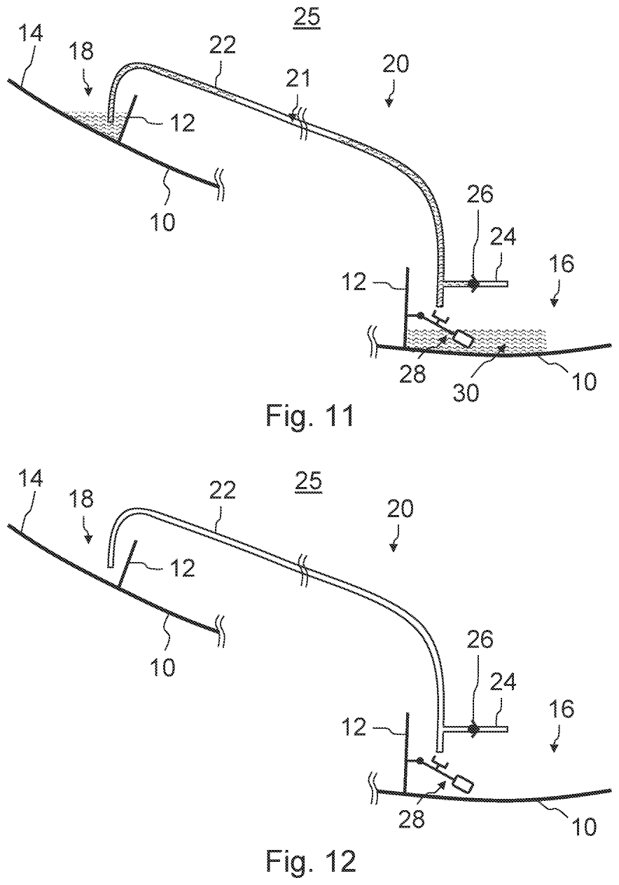

When the tank is being emptied due to the pumping of fuel to supply the propulsion engines of the aircraft, the fuel level 30 drops in the tank until it reaches a first emptying level as illustrated in FIG. 9. This level is such that the reinforcing profile 12 associated with the retention zone is no longer submerged in the fuel 30 and, consequently, the fuel retention zone 18 is no longer submerged in the fuel 30. In other words, the fuel retention zone 18 is no longer covered with fuel. However, the retention zone 18 remains full of fuel. Thanks to the non-return valve 26 and the float valve 28, the fuel contained in the pipe 22 remains in the pipe. By continuing to empty the tank, the fuel level 30 drops in the tank until it reaches a second emptying level as illustrated in FIG. 10. The bypass conduit 24 then emerges from the fuel 30. However, thanks to the non-return valve 26, the fuel contained in the pipe 22 remains in the pipe. By continuing to empty the tank further, the fuel level 30 drops in the tank so that this fuel level is no longer sufficiently high to lift the float of the float valve 28, as illustrated in FIG. 11. This has the effect of opening the float valve. Consequently, the fuel contained in the pipe 22 flows through the second end of the pipe to the pumping zone 16. Given that the first end of the pipe 22 is submerged in the fuel contained in the retention zone 18, the pipe 22 acts as a siphon and the flow of fuel contained in the pipe has the effect of siphoning the fuel contained in the retention zone 18 and therefore emptying the retention zone 18. The possible presence of the air bubble 21 does not pose a problem, to the extent that this air bubble is carried to the second end of the pipe 22 during the flow of fuel. Even though this is not shown in the figures for reasons of clarity, the first end of the pipe 22 is preferably positioned as low as possible in a lower part of the retention zone 18, to allow for the best possible emptying of the fuel contained in the retention zone 18. This allows for the transfer of almost all of the fuel contained in the retention zone 18 to the pumping zone 16 and, consequently, for the pumping of all the fuel 30 contained in the tank. FIG. 12 illustrates the tank 25 after the pumping of the fuel is complete.

The passive fuel transfer system 20 is advantageous in that the siphon formed by the pipe 22 is automatically initiated during the tank filling process, due to the fact that the pipe 22 is filled via the bypass conduit 24 and due to the fact that the first end of the pipe 22 is submerged in the fuel contained in the retention zone from the point at which the retention zone 18 is filled with fuel.

In one embodiment, the tank 25 comprises a set of fuel transfer systems similar to the fuel transfer system 20 described above. A fuel transfer system is associated with a retention zone associated with each reinforcing profile belonging to a set of reinforcing profiles of the panel 10. Therefore, during the tank emptying process, this allows the emptying of the set of retention zones 18 associated with the different reinforcing profiles belonging to the set of profiles to be guaranteed. Advantageously, the set of reinforcing profiles corresponds to all or part of the reinforcing profiles of the upper side panel 10 in the lower part 11 of the tank.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. An aircraft comprising:
a fuel tank such that a lower wall of the fuel tank corresponds to a panel of a structure of the aircraft, said panel being provided with a plurality of reinforcing profiles,
a fuel pumping zone provided in a lower part of the fuel tank so as to allow fuel to be pumped to at least one fuel consumer, and
a fuel retention zone associated with at least one reinforcing profile, said fuel retention zone delimited by the lower wall of the fuel tank and by the at least one reinforcing profile,
wherein the fuel tank comprises a set of passive fuel transfer systems, each passive fuel transfer system being installed between, on one hand, a fuel retention zone associated with a reinforcing profile and, on another hand, the lower part of the fuel tank, and
wherein each passive fuel transfer system is configured to allow fuel retained in the retention zone associated with the reinforcing profile to be siphoned in such a manner that this fuel is transferred to the pumping zone when a fuel level in the fuel tank is such that the retention zone is not covered by fuel.

2. The aircraft according to claim 1, wherein each passive fuel transfer system comprises a pipe, a first end of which is located in the fuel retention zone and a second end is located in the lower part of the fuel tank.

3. The aircraft according to claim 2, wherein the pipe is comprises a bend closer to the first end then the second end, in order to bypass the reinforcing profile associated with the retention zone.

4. The aircraft according to claim 2, wherein the first end of the pipe is located in a lower part of the retention zone.

5. The aircraft according to claim 2, wherein each passive fuel transfer system comprises a bypass conduit, a first end of which is connected to the pipe, closer to the second end of the pipe than the first end of the pipe, and a second end of which opens freely into the lower part of the tank.

6. The aircraft according to claim 5, wherein a non-return valve is serially mounted on the bypass conduit in such a manner as to prevent a circulation of fuel towards the second end of the bypass conduit.

7. The aircraft according to claim 2, wherein each passive fuel transfer system comprises a float valve mounted on the second end of the pipe and configured in such a manner that the float valve is closed when a fuel level in the lower part of the fuel tank is sufficiently high to lift a float of the float valve and in such a manner that the float valve is open when the fuel level is not sufficiently high to lift the float.
